(19) United States
(12) Patent Application Publication
(10) Pub. No.: US 2022/0388132 A1
(43) Pub. Date: Dec. 8, 2022

(54) WRENCH

(71) Applicant: PING-CHUN CHEN, Taichung City (TW)

(72) Inventor: PING-CHUN CHEN, Taichung City (TW)

(21) Appl. No.: 17/888,508

(22) Filed: Aug. 16, 2022

Related U.S. Application Data
(63) Continuation-in-part of application No. 17/011,998, filed on Sep. 3, 2020.

(51) Int. Cl. B25B 23/00; B25B 13/46

(52) U.S. Cl. CPC B25B 23/0035; B25B 13/463

(57) ABSTRACT

A wrench includes a ratchet unit located in the head and includes a mount hole. A collar is connected to the head and includes a slot and an aperture. A C-shaped engaging member includes a first end thereof inserted into the aperture. A second end of the engaging member protrudes beyond the collar. The engaging member includes a second section which is a curved section and resiliently protruded into the slot. A rotary member is mounted to outer periphery of the collar and includes a notch defined in the underside thereof. The second end of the engaging member is located in the notch and covered by the rotary member. When the rotary member is rotated, the engaging member is deformed to insert or remove the second section relative to the mount hole via the slot to position a socket in the head of the wrench.

### BACKGROUND OF THE INVENTION

### 1. Fields of the Invention

This a Continuation-In-Part patent application of applicant's former patent application with application Ser. No. 17/011,998, filed on Sep. 3, 2020.

### 2. Descriptions of Related Art

The conventional wrench known to applicant discloses an engaging member which includes a portion that is resiliently protruded into the wrench head so as to position a socket connected to the head of the wrench. However, there are different types of sockets to be used with the wrench, and the sockets may have different number of faces or sides. When the socket is connected to the head of the wrench, the portion that is designed to be protruded into the head of the wrench to position the socket may be parallel with one of the sides of the socket. In this situation, the socket cannot be well positioned by the portion of the engaging member. In other words, the function of the engaging member fails, and the socket may drop from the head of the wrench.

U.S. Pat. No. 9,592,594 to Chen discloses a C-shaped retaining ring that has a hook portion and a straight leg, wherein the hook portion is inserted into an aperture of the wrench, and the straight leg has a portion located within the mount hole of the wrench and a distal end of the straight leg is operated to be pushed outward so as to remove the portion of the straight leg out from the mount hole of the wrench. The portion of the straight leg in the mount hole of the wrench is engaged one of the corner of the socket that is connected to the wrench. However, the straight leg can touch only one corner of the socket, and this may not hold the socket during operation.

US 2018/0318989 to Lin discloses a U-shaped locking member which includes an operation portion, two locking portions and two limit portions. As shown in FIG. 11 of Lin, the two locking portions of the U-shaped locking member are protruded into the wrench to hold the socket via two slots. As shown in FIG. 12, when the user pushes the operation portion toward the socket, the two locking portions are forced to expand outward to allow the socket to be removed from the wrench. Although there are two corners of the socket connected to the wrench are engaged with the two locking portions of the U-shaped portions, however, because the U-shaped locking member is a small and short element, so that it is difficult to cause the deformation of the two locking portions by pushing the operation portion toward the socket. This is because that the U-shaped locking member is required to be strong enough to hold the socket during operation, however, the strong U-shaped locking member is difficult to be deformed simply by pushing the operation portion of the U-shaped locking member. On the contrary, if the U-shaped locking member is easily to be deformed by pushing the operation portion, the U-shaped locking member can be easily deformed and cannot hold the socket properly during operation of the wrench. Besides, the two slots that allow the two locking portions to be protruded into the wrench weaken the strength of the wrench.

The present invention intends to provide a wrench with an engaging member which includes a curved section to be protruded into the head of the wrench so as to hold at least two corners of different types of sockets.

### SUMMARY OF THE INVENTION

The present invention relates to a wrench which comprises a handle and a head formed to an end of the handle. The head includes a first through hole defined axially therethrough, and a ratchet unit is located in the first through hole. The ratchet unit includes a tubular member which includes a mount hole defined axially therethrough. A collar includes a second through hole defined axially therethrough. The collar is connected to the through hole and located corresponding to the mount hole. A slot and an aperture are defined radially through the collar. an engaging member mounted to an outer periphery of the collar and including a first end, a first section, a second section and a second end, the first end of the engaging member inserted into the aperture of the collar, the second section of the engaging member being a curved section and resiliently protruded into the slot, the second end of the engaging member protruding beyond the collar. The engaging member has a center, and the second section includes a recessed and curved inside that faces the center of the engaging member. The recessed and curved inside of the second section of the engaging member is resiliently protruded into the mount hole via the slot of the collar so as to hold a socket in the mount hole. A rotary member is mounted to outer periphery of the collar. A notch is defined in the underside of the rotary member. The second end of the engaging member is located in the notch and covered by the rotary member.

When the rotary member is rotated, the engaging member is deformed, and the second section of the engaging member is insert into the mount hole via the slot to hole a socket in the mount hole, or is remove from the mount hole via the slot.

The present invention also provides another embodiment of the wrench and comprises a handle and a head formed to an end of the handle. The head includes a first through hole defined axially therethrough, and a ratchet unit is located in the first through hole. The ratchet unit includes a tubular member which includes a mount hole defined axially therethrough. A collar includes a second through hole defined axially therethrough. The collar is connected to the through hole and located corresponding to the mount hole. A slot and an aperture are defined radially through the collar. An engaging member includes a first end, a first section, a second section and a second end, wherein the first end of the engaging member is inserted into the aperture of the collar, and the second end of the engaging member protrudes beyond the collar. The second section of the engaging member is a curved section and resiliently protruded into the slot. The engaging member has a center, and the second section includes a recessed and curved inside that faces the center of the engaging member. The recessed and curved inside of the second section of the engaging member is resiliently protruded into the mount hole via the slot of the collar so as to hold a socket in the mount hole. A rotary member is mounted to outer periphery of the collar. A notch is defined in the underside of the rotary member. The second end of the engaging member is located in the notch and covered by the rotary member. The socket includes a tubular portion and a reception portion which is formed to one end of the tubular portion. The tubular portion includes multiple ridges extending from the outer periphery thereof. Multiple positioning ditches are formed in each of the ridges so as to form each ridge to be first portion, a second portion and a third portion. The third portion is formed with the reception portion. The recessed and curved inside of the second section of the engaging member is resiliently engaged with the positioning ditches to position the socket to the head of the wrench.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the wrench of the present invention;

FIG. 2 is another perspective view to show the wrench of the present invention;

FIG. 3 is an exploded view of the wrench of the present invention;

FIG. 4 is an exploded view of the second embodiment of the wrench of the present invention;

FIG. 5 is a perspective view to show that the socket is connected to the wrench of the present invention as disclosed in FIG. 4;

FIG. 6 is a top view of the disclosure of FIG. 5;

FIG. 7 is a cross sectional view, taken along line VII-VII in FIG. 5;

FIG. 8 is a cross sectional view showing that the engaging member is engaged with the positioning ditches of the socket;

FIG. 9 shows that the rotary member is rotated and the second section of the engaging member is deformed, and

FIG. 10 shows that the second section of the engaging member is disengaged from the positioning ditches of the socket.

### DETAILED DESCRIPTION OF THE PREFERRED EMBODIMENT

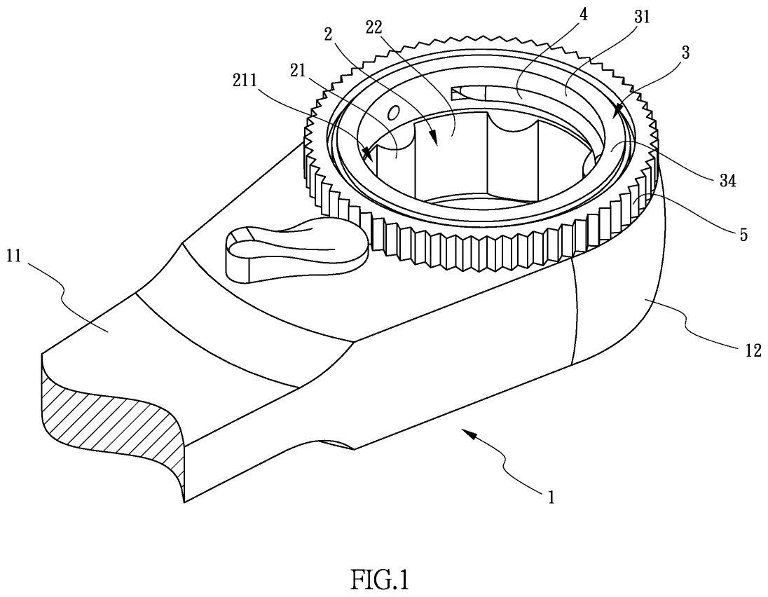

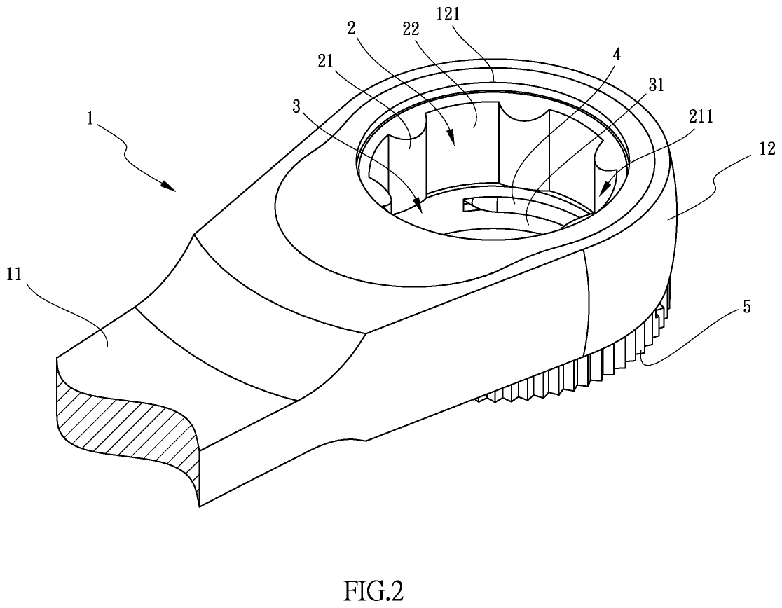

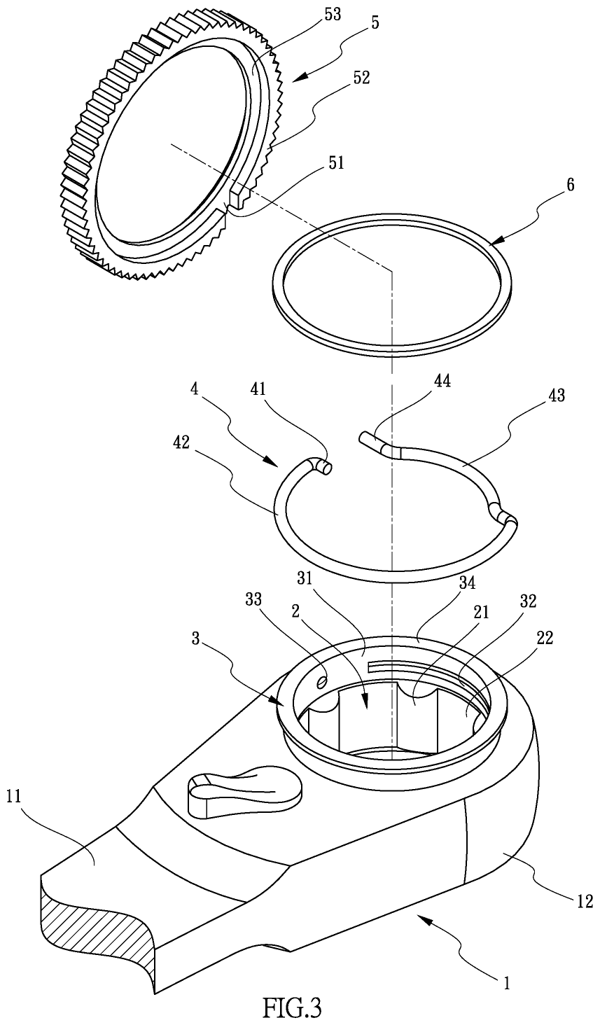

Referring to FIGS. 1 to 3, the wrench 1 of the present invention comprises a handle 11 and a head 12 which is formed to one end of the handle 11. The head 12 includes a first through hole 121 (FIG. 2) defined axially therethrough, and a ratchet unit 2 is located in the first through hole 121 of the head 12. The ratchet unit 2 includes a tubular member 21 which is controlled by a ratchet mechanism (not shown). The tubular member 21 includes a mount hole 211 defined axially therethrough. Multiple grooves 22 are formed in the inner periphery of the mount hole 211 of the tubular member 21.

A collar 3 is a ring-shaped member and includes a second through hole 31 defined axially therethrough. The collar 3 is connected to the through hole 121 and located corresponding to the mount hole 211. A slot 32 and an aperture 33 are respectively defined radially through the collar 3 and both communicate with the second through hole 31.

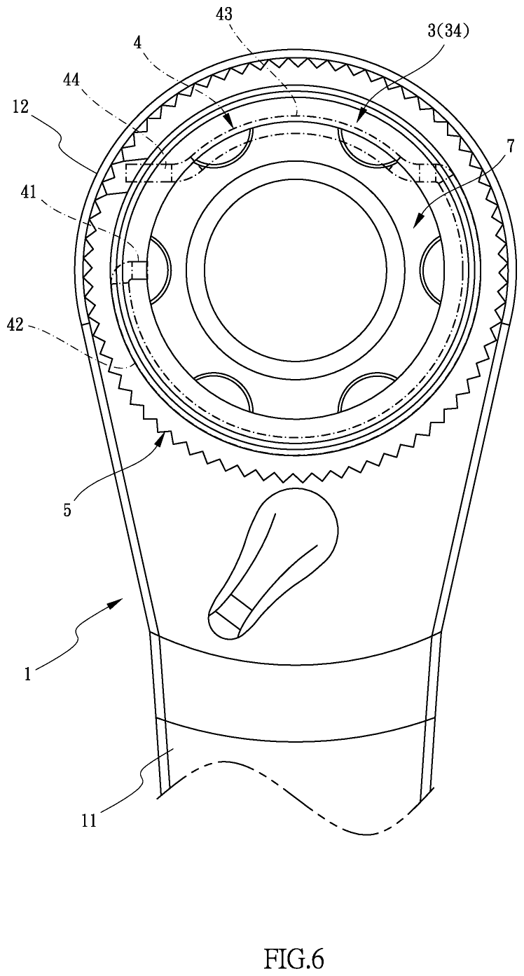

An engaging member 4 is a C-shaped member and mounted to the outer periphery of the collar 3. The engaging member 4 includes a first end 41, a first section 42, a second section 43 and a second end 44. The first end 41 of the engaging member 4 is inserted into the aperture 33 of the collar 3. The second end 44 of the engaging member 4 protrudes beyond the collar 3. The first section 42 is located at the outer periphery of the collar 3, and the second section 43 of the engaging member 4 is a curved section and resiliently protruded into the slot 32. The second section 43 of the engaging member 4 has a center which is located axially aligned with the center of the mount hole 211. The second section 43 includes a recessed and curved inside that faces the center of the second section 43 of the engaging member 4. The recessed and curved inside of the second section 43 of the engaging member 4 is resiliently protruded into the mount hole 211 via the slot 32 of the collar 3 so as to hold a socket in the mount hole 211 as shown in FIG. 6. The first end 41 of the engaging member 4 is inserted into the aperture 33 of the collar 3 from the outer periphery of the collar 3. Specifically, the recessed and curved inside of the second section 43 of the engaging member 4 matches the outer contour of the socket 7. Therefore, the recessed and curved inside of the second section 43 of the engaging member 4 is easily engaged with the positioning ditches 72 of the socket 7 properly hold the socket 7 during operation of the wrench as shown in FIG. 6.

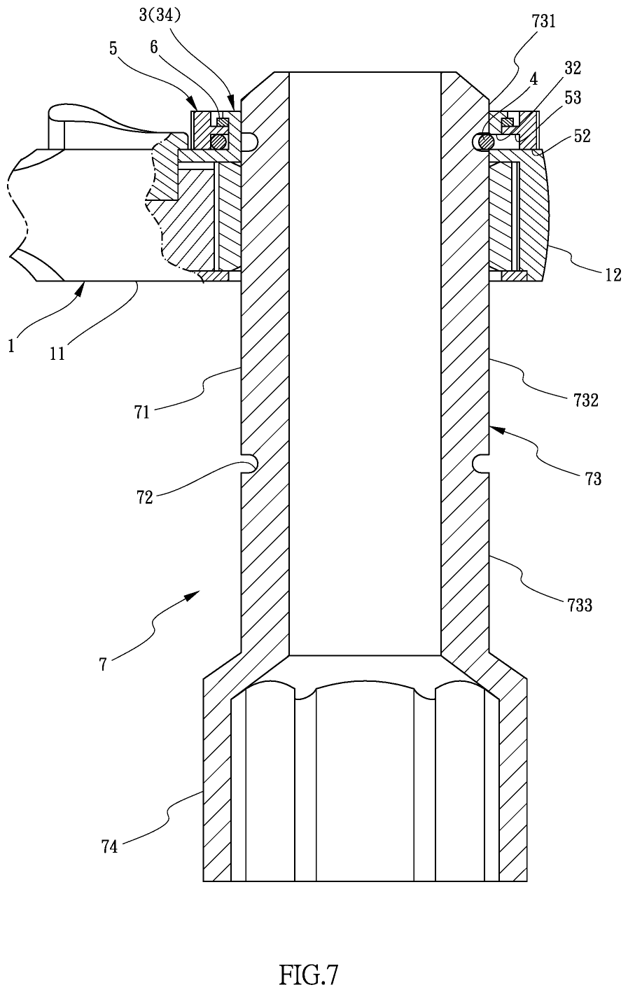

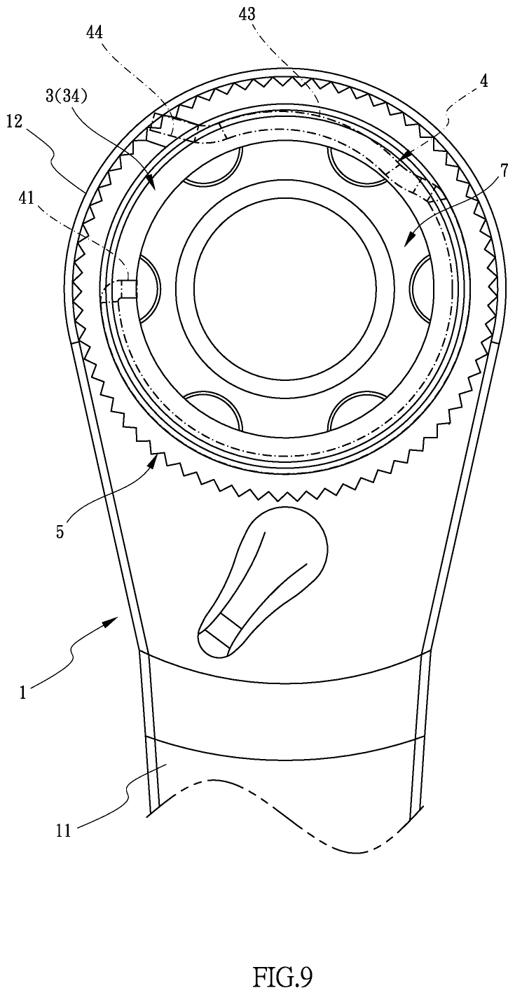

A rotary member 5 is a ring-shaped member and mounted to the outer periphery of the collar 3. The rotary member 5 includes an outer portion 52 and a flange 53 extends from the inner periphery of the outer portion 52. The outer portion 52 includes uneven surface so that the users can easily rotate the rotary member 5. A notch 51 is formed in the outer portion 52 and located at the underside of the rotary member 5. The second end 44 of the engaging member 4 is located in the notch 51 and covered by the rotary member 5 so that the second end 44 of the engaging member 4 cannot be seen from outer appearance of the wrench 1. A ring 6 is mounted to the outer periphery of the collar 3 so as to restrict the rotary member 5 from loosening. The collar 3 includes a lip 34 extending radially outward from the top thereof. The ring 6 is located between the lip 34 and the rotary member 5 as shown in FIG. 7. It is noted that the second end 44 of the engaging member 4 is located in the notch 51 of the rotary member 5, so that when the rotary member 5 is rotated in one direction, the inside wall of the notch 51 drives the second end 44 of the engaging member 4 with the rotation of the rotary member 5. That is to say, when the rotary member 5 is rotated clockwise in FIG. 9, the second end 44 of the engaging member 4 is brought to move outwardly and away from the socket 7 in the mount hole 211, the recessed and curved inside of the second section 43 of the engaging member 4 is moved into the slot 32 of the collar 3. The recessed and curved inside of the second section 43 of the engaging member 4 is removed from the socket 7 which is able to be disengaged from the wrench.

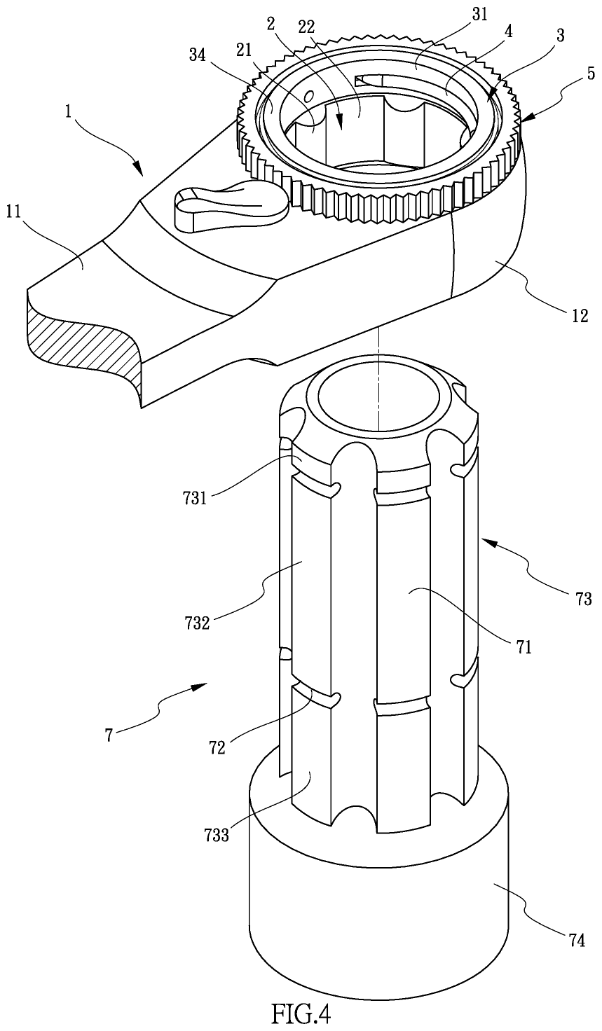

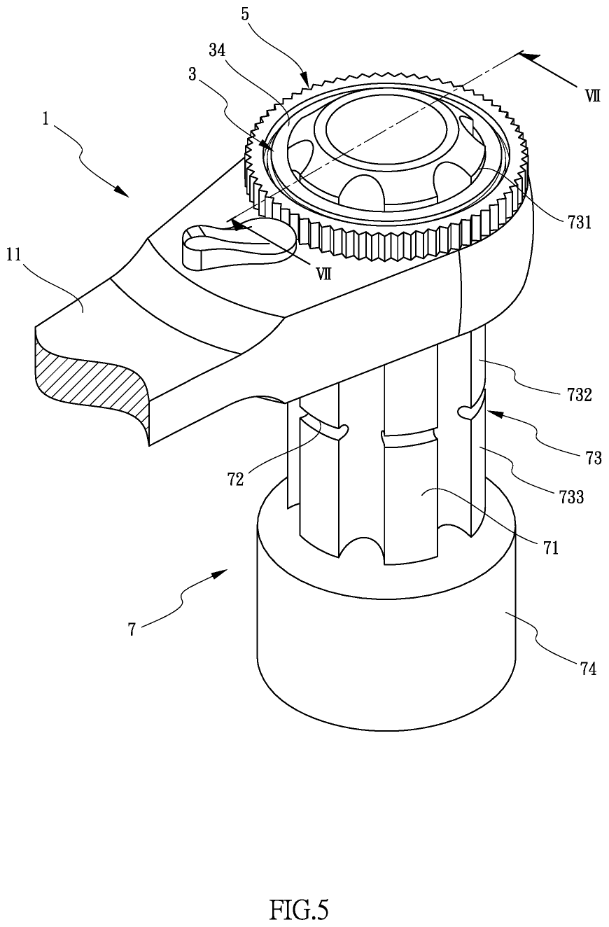

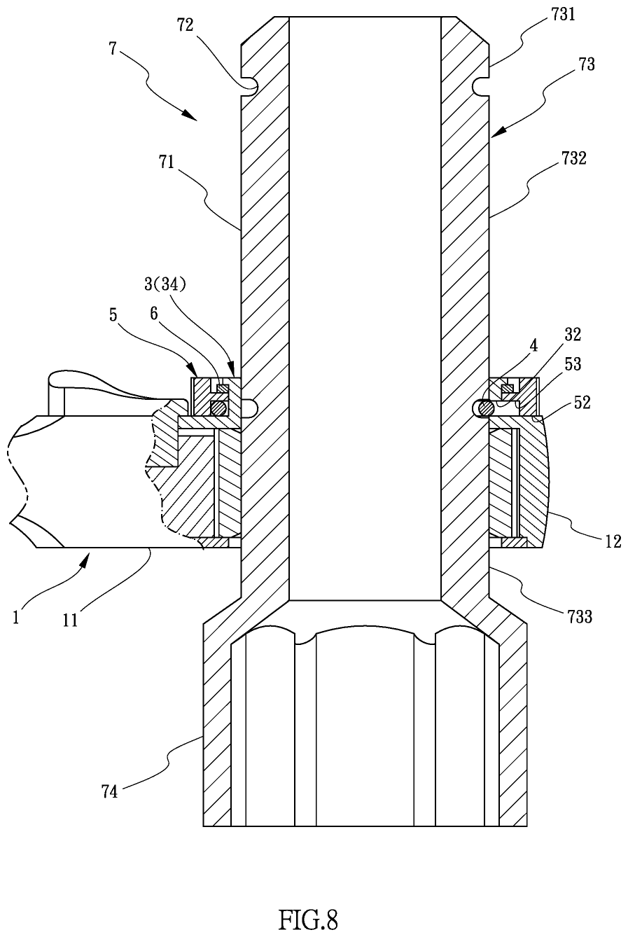

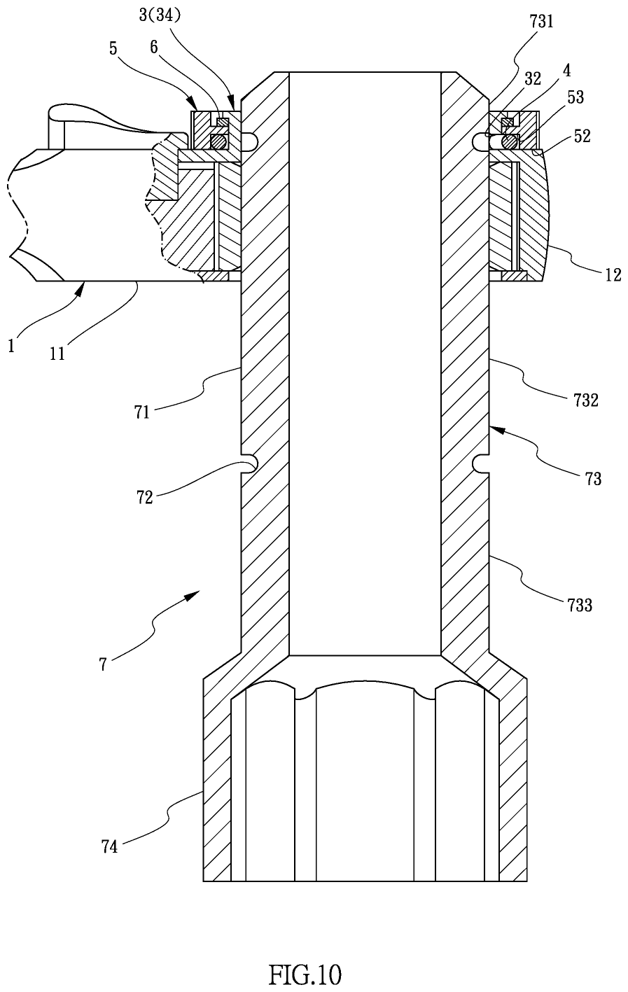

As shown in FIGS. 4-10, a socket 7 is able to be connected to the wrench 1 of the present invention, wherein the socket 7 includes a tubular portion 73 and a reception portion 74 which is formed to one end of the tubular portion 73. The reception portion 74 includes a reception room so as to accommodate an object such as a bolt head or a nut (not shown). The tubular portion 73 includes multiple ridges 71 extending from the outer periphery thereof, and the ridges 71 are parallel to the axial axis of the tubular portion 73. Multiple positioning ditches 72 are formed transversely in each of the ridges 71 so as to form each ridge 71 to be first portion 731, a second portion 732 and a third portion 733. The third portion 733 is formed with the reception portion 74.

As shown in FIGS. 6 to 10, the tubular portion 73 is inserted into the mount hole 211 of the ratchet unit 2, and the ridges 71 of the socket 7 are slidably engaged with the grooves 22 of the mount hole 211. The distance of the reception portion 74 of the socket 7 relative to the head 12 of the wench 1 can be adjusted by moving the tubular portion 73 through the mount hole 211. The second section 43 of the engaging member 4 protrudes into the mount hole 211 via the slot 32 and are engaged with the positioning ditches 72 of the ridges 71 of the socket 7 when connecting the socket 7 to the wench 1. The recessed and curved inside of the second section 43 of the engaging member 4 is engaged with the positioning ditches 72 of the ridges 71 of the socket 7 so that the socket 7 is positioned relative to the head 12 of the wrench 1. When the rotary member 5 is rotated clockwise as shown in FIG. 9, the second end 44 of the engaging member 4 is brought to move outwardly and away from the socket 7 in the mount hole 211, and the recessed and curved inside of the second section 43 of the engaging member 4 is moved into the slot 32 of the collar 3. The second section 43 of the engaging member 4 is removed from the mount hole 211 via the slot 32. The recessed and curved inside of the second section 43 is disengaged from the positioning ditches 72 of the ridges 71 of the socket 7, such that the socket 7 can be moved relative to the head 12 of the wrench 1.

The present invention provides the engaging member 4 that includes the second section 43 which has the recessed and curved inside which matches with the outer contour of the socket 7 so as to easily engage with multiple positioning ditches 72 of the socket 7. When rotating the rotary member 5, the second end 44 of the engaging member 4 is easily pulled away from the socket 7, so that the recessed and curved inside of the second section 43 of the engaging member 4 is disengaged from the positioning ditches 72 of the socket 7, and the socket 7 can be freely moved relative to the wrench 1. The present invention improves the shortcomings of US 2018/0318989 which has to push hard the U-shaped locking member toward the socket. The present invention requires only one slot 32 defied through the collar 3, so that the collar has better structure strength comparted with US 2018/0318989 that requires two slots.

The recessed and curved inside of the second section 43 of the engaging member 4 is easily engaged with multiple positioning ditches 72 of the socket 7 because the curvature of the recessed and curved inside of the second section 43 of the engaging member 4 of the present invention matches the outer contour of the socket 7. Therefore, the shortcoming of U.S. Pat. No. 9,592,594 is improved.

While we have shown and described the embodiment in accordance with the present invention, it should be clear to those skilled in the art that further embodiments may be made without departing from the scope of the present invention.

What is claimed is:

1. 1. A wrench comprising:
a handle and a head formed to an end of the handle, the head including a first through hole defined axially therethrough, a ratchet unit located in the first through hole of the head and including a tubular member, the tubular member including a mount hole defined axially therethrough;
a collar being a ring-shaped member and including a second through hole defined axially therethrough, the collar connected to the through hole and located corresponding to the mount hole, a slot defined radially through the collar and communicating with the second through hole, an aperture defined radially through the collar;
an engaging member mounted to an outer periphery of the collar and including a first end, a first section, a second section and a second end, the first end of the engaging member inserted into the aperture of the collar, the second section of the engaging member being a curved section and resiliently protruded into the slot, the second end of the engaging member protruding beyond the collar, the second section of the engaging member having a center which is located axially aligned with a center of the mount hole, the second section including a recessed and curved inside that faces the center of the second section of the engaging member, the recessed and curved inside of the second section of the engaging member resiliently protruded into the mount hole via the slot of the collar so as to hold a socket in the mount hole, and
a rotary member being a ring-shaped member and mounted to the outer periphery of the collar, a notch defined in an underside of the rotary member, the second end of the engaging member located in the notch and being covered by the rotary member, the second end of the engaging member being moved outward and away from the head of the wrench, and the recessed and curved inside of the second section of the engaging member being moved into the slot of the collar.

2. The wrench as claimed in claim 1 further comprising a ring mounted to the outer periphery of the collar, the collar including a lip extending radially outward from a top thereof, the ring is located between the lip and the rotary member.

3. The wrench as claimed in claim 1, wherein the rotary member includes an outer portion and a flange extending from an inner periphery of the outer portion, the notch is formed in the outer portion, the second end of the engaging member is located in the notch of the rotary member, when the rotary member is rotated, the engaging member is deformed.

4. The wrench as claimed in claim 1, wherein a center of the second section of the engaging member is axially aligned with a center of the mount hole of the tubular member of the ratchet unit.

5. A wrench comprising:
a handle and a head formed to an end of the handle, the head including a first through hole defined axially therethrough, a ratchet unit located in the first through hole of the head and including a tubular member, the tubular member including a mount hole defined axially therethrough;
a collar being a ring-shaped member and including a second through hole defined axially therethrough, the collar connected to the through hole and located corresponding to the mount hole, a slot defined radially through the collar and communicating with the second through hole, an aperture defined radially through the collar;
an engaging member mounted to an outer periphery of the collar and including a first end, a first section, a second section and a second end, the first end of the engaging member inserted into the aperture of the collar, the second section of the engaging member being a curved section and resiliently protruded into the slot, the second end of the engaging member protruding beyond the collar,
the second section of the engaging member having a center which is located axially aligned with a center of the mount hole, the second section including a recessed and curved inside that faces the center of the second section of the engaging member, the recessed and curved inside of the second section of the engaging member resiliently protruded into the mount hole via the slot of the collar;
a rotary member being a ring-shaped member and mounted to the outer periphery of the collar, a notch defined in an underside of the rotary member, the second end of the engaging member located in the notch and being covered by the rotary member, and
a socket including a tubular portion and a reception portion which is formed to an end of the tubular portion, the tubular portion including multiple ridges extending from an outer periphery thereof, multiple positioning ditches formed in each of the ridges so as to form each ridge to be first portion, a second portion and a third portion, the third portion formed with the reception portion, the recessed and curved inside of the second section engaged with the positioning ditches; when the rotary member is rotated in one direction to pull the second end of the engaging member outwardly and away from the socket, the recessed and curved inside of the second section of the engaging member is moved into the slot of the collar, and the recessed and curved inside of the second section is removed from the positioning ditches of the socket.

6. The wrench as claimed in claim 5 further comprising a ring mounted to the outer periphery of the collar, the collar including a lip extending radially outward from a top thereof, the ring is located between the lip and the rotary member.

7. The wrench as claimed in claim 6, wherein the rotary member includes an outer portion and a flange extending from an inner periphery of the outer portion, the notch is formed in the outer portion, the second end of the engaging member is located in the notch of the rotary member, when the rotary member is rotated, the engaging member contacts an inside of the notch and is driven and deformed by the rotary member.

8. The wrench as claimed in claim 5, wherein multiple grooves are formed in an inner periphery of the mount hole of the tubular member, the ridges of the socket are slidably engaged with the grooves of the mount hole, the second section of the engaging member protrudes into the mount hole and engaged with the positioning ditches of the ridges of the socket.

9. The wrench as claimed in claim 5, wherein a center of the second section of the engaging member is axially aligned with a center of the mount hole of the tubular member of the ratchet unit.

10. The wrench as claimed in claim 5, wherein the recessed and curved inside of the second section of the engaging member matches an outer contour of the socket.
